(19) United States
(12) Patent Application Publication
(10) Pub. No.: US 2024/0004738 A1
(43) Pub. Date: Jan. 4, 2024

(54) MANAGEMENT OF IMPRESSION CONTENT

(71) Applicant: Pubguard Limited, London (GB)

(72) Inventor: Francesco PETRUZZELLI, London (GB)

(21) Appl. No.: 17/852,779

(22) Filed: Jun. 29, 2022

(51) Int. Cl. G06F 9/54

(52) U.S. Cl. CPC G06F 9/547; G06F 9/541

(57) ABSTRACT

Methods, systems and user devices for managing impression content a framework comprising at least one provisioning server configured to generate impression content; a remote server for generating an ordered mediation chain of requests for impression content, and ordered in accordance with a predetermined metric; and API. Impression content is requested from the provisioning server, based on a first request the ordered mediation chain, and the received impression content is analyzed to determine whether it meets predetermined requirements. Further impression content is requested from the provisioning server based on a next request, different from the first request, in the ordered mediation chain, when the analyzed impression content does not meet the predetermined requirements.

### BACKGROUND OF THE INVENTION

### Field of the Invention

The present disclosure relates to methods, systems, and user devices for managing impression content. The disclosure has particular, but not exclusive, relevance to the management of impression content from multiple sources.

### Description of the Related Technology

The popularity of mobile devices such as smartphones and other form factors, such as laptop computers and tablet computers has risen meteorically in recent years. There are a number of revenue streams available to developers of applications for execution on a user device. Previously developers and companies providing services through one or more software applications made money through the sale of software on physical media (laserdiscs and cartridges). Nowadays, software is more often downloaded on connected mobile devices. Whilst this model still allows commercial entities to make money from the sale of software, it is common for further revenue streams to be pursued based on the sale of advertising space, including advertising space within the software itself. In some software, such as video games, adverts may be presented to a user as part of a loading screen or menu, or maybe rendered within a computer-generated environment during gameplay, leading to the notion of in-game advertising. For example, in a sports game, advertising boards within a stadium may present adverts for real-life products. In an adventure game or first-person shooting game, adverts for real-life products may appear on billboards or other objects within the game environment.

Revenue models based on the sale of advertising space are ubiquitous in the context of film and television, as well as for websites and social media applications. The term “impression content” is commonly used in the industry to refer to content, such as an advertisement, for which an advertiser would be charged depending on the expected or actual reach of a given advert in accordance with an advertising revenue model. For television and film, an advertising fee may be negotiated based on several showings of the advert and the predicted audience size for each showing. For a website or social media application, the advertising fee may be related to several page views or clicks. The distribution of an advert may then be controlled in dependence on these factors.

In the above cases, it is technically straightforward to predict and measure the number of advertising impressions experienced by users. However, with the increased prevalence of online advertisements, and the presentation of the advertisements in different software programs, in some cases, inappropriate advertisements may be displayed within the software. Such inappropriate advertisements may be flagged by users of the device, causing, e.g. the advertisement space to be cleared. This has at least two drawbacks: first, because selection of advertisements currently depends on user feedback, all advertisements are sent and displayed to users; consequently, inappropriate advertisements will be displayed at times. Second, this may result in a reduction in revenues earned by the developer, since there is a blank advertisement spot for a period of time, whilst a replacement advertisement is sourced.

Tracking the receipt of the advertisement at individual user devices and monitoring whether the advertisement is appropriate, as well as selecting a replacement advertisement, is a complex and computationally expensive process.

### SUMMARY

In accordance with a first aspect of the present disclosure, there is provided a method for managing impression content at a user device using a framework, the framework comprising at least one provisioning server configured to generate impression content; a remote server configured to generate an ordered mediation chain comprising a plurality of requests for the impression content generated by the at least one provisioning server, wherein the ordered mediation chain is ordered in accordance with a predetermined metric; and an application programming interface, API, for sending and receiving data between the user device, and the remote server and the provisioning server; the method comprising requesting, from the remote server using the API, the ordered mediation chain; receiving, from the remote server, the ordered mediation chain; requesting, from the at least one provisioning server using the API, impression content, based on a first request of said plurality of requests of the ordered mediation chain; receiving, from the at least one provisioning server, the requested impression content; analyzing the received impression content to determine whether the received impression content meets predetermined requirements; and requesting, from the provisioning server using the API, further impression content based on a next request, different from the first request, of the plurality of requests in the ordered mediation chain, when the analyzed impression content does not meet the predetermined requirements. By generating an ordered mediation chain at the remote server, where the ordered mediation chain is ordered in accordance with a predetermined metric, a user device can access suitable impression content quickly and efficiently, whilst preventing the provision of inappropriate and/or offensive impression content. Analyzing the impression content, on receipt, at the user device ensures that other impression content can be obtained from a provisioning server without delay and in an order of preference as specified by the ordered mediation chain. This also improves the user experience by ensuring that there is suitable impression content available at the user device. It also reduces the processing requirements of the remote server which may be responsible for handling requests for impression content from multiple user devices.

Preferably, the method also comprises the step of initialising a tendering process, the tendering process to be executed on the at least one provisioning server, for impression content which meets the predetermined requirements, when the ordered mediation chain contains no requests for the impression content meeting the predetermined requirements. Default impression content may be shown during the execution of the tendering process. This enables a tendering process to be initialized such that where there are no suitable requests for impression content (that is the impression content associated with the requests of the ordered mediation chain do not meet the predetermined requirements), suitable impression content can be obtained from a provisioning server, improving the user experience. Furthermore, whilst the tendering process is being executed, default impression content may be displayed also improving the user experience.

The step of analyzing the received impression content may comprise applying at least one machine learning algorithm to analyze at least any media items contained within the impression content; any text contained within the impression content, and any remote content associated with the impression content. This enables the analysis of the received impression content to consider a number of criteria and factors when determining whether it meets the predetermined requirements. By using a machine learning algorithm trained to do this, a more accurate and quicker analysis can be undertaken.

Optionally, the predetermined metric is based on at least one of a cost metric of the impression content associated with historical data of the provisioning server providing the impression content; and a quality metric of the impression content associated with historical data of the provisioning server providing the impression content. This enables the ordered mediation chain to be ordered based on the return and/or quality of each of the impression content, thereby ensuring higher quality/return impression content is requested first.

The predetermined requirements may include at least one of an age rating filter; a blacklist filter; a list of approved publishers of the impression content; and a list of approved provisioning servers for providing the impression content. The predetermined requirements may be configurable by a user of the user device. This enables the predetermined requirements to specify different types of impression content which are acceptable/suitable based on any number of factors, and enables the customization of the predetermined requirements by the user.

Preferably, the method further comprises the step of displaying the analyzed impression content on a display associated with the user device when the analyzed impression content meets the predetermined requirements. This enables the impression content to be displayed to the user when it is determined that it is acceptable and/or suitable.

According to a second aspect of the present disclosure, there is provided a method for managing impression content at a remote server using a framework, the framework comprising at least one provisioning server configured to generate impression content; a remote server configured to generate an ordered mediation chain comprising a plurality of requests for the impression content generated by the at least one provisioning server, wherein the ordered mediation chain is ordered in accordance with a predetermined metric; an application programming interface, API, for sending and receiving data between at least the user device and the remote server; the method comprising receiving, from the user device using the API, a request for impression content; requesting, from the at least one provisioning server, impression content, based on a first request of said plurality of requests of the ordered mediation chain; receiving, from the at least one provisioning server, the requested impression content; analyzing the received impression content to determine whether the received impression content meets predetermined requirements; and requesting, from the at least one provisioning server, further impression content based on a next request, different from the first request, of the plurality of requests in the ordered mediation chain, when the analyzed impression content does not meet the predetermined requirements. By generating an ordered mediation chain at the remote server, where the ordered mediation chain is ordered in accordance with a predetermined metric, a user device can access suitable impression content quickly and efficiently, whilst preventing the provision of inappropriate and/or offensive impression content. Analyzing the impression content, on receipt, at the remote server ensures that other impression content can be obtained from a provisioning server without delay, and in an order of preference as specified by the ordered mediation chain. Furthermore, by undertaking the method at the remote server, this ensures that acceptable impression content can be obtained quicker thereby improving the user experience, and reducing the processing requirements of the user device which may be performing other processing tasks.

The remote server, on receipt of the request for the ordered mediation chain, may determine which of the at least one provisioning server to send requests for the impression content and constructs the ordered mediation chain based on the determination. This enables the remote server to determine whether to include requests for impression content from certain provisioning servers, based on any number of factors, such as a quality and/or cost threshold. This results in a reduction of requests for impression content, reducing bandwidth and unnecessary processing.

Preferably, the method may further comprise the step of ordering the ordered mediation chain in accordance with a predetermined metric, wherein the predetermined metric is at least one of a cost metric of the impression content associated with historical data of the provisioning server providing the impression content; and a quality metric of the impression content associated with historical data of the provisioning server providing the impression content. This enables the ordered mediation chain to be ordered based on the return and/or quality of each of the impression content, thereby ensuring higher quality/return impression content is requested first.

The method may further comprise storing the analyzed impression content in storage accessible to the provisioning server, and storing an indication in the storage that the analyzed impression content does not meet the predetermined requirements. Furthermore, the method may comprise transmitting, to the provisioning server, the indication, when it is determined that the impression content does not meet the predetermined requirements. This enables the impression content to be flagged such that inappropriate content is tracked and can be handled appropriately, by storing the indication in the storage and transmitting it to the provisioning server, future requests for the inappropriate impression content can be quickly and efficiently identified, further improving the user experience.

Optionally, the method further comprises transmitting, to the user device using the API, the analyzed impression content, when it is determined that the analyzed impression content meets the predetermined requirements. This enables the impression content to be displayed to the user when it is determined that it is acceptable and/or suitable.

According to a third aspect of the present disclosure, there is provided a user device configured to manage impression content requested from a distributed system, the distributed system comprising at least one provisioning server configured to generate impression content; a remote server configured to generate an ordered mediation chain for managing a plurality of requests for the impression content, generated by the at least one server, wherein the mediation chain is ordered in accordance with a predetermined metric; an application programming interface, API, for sending and receiving data between the user device, and the remote server and the provisioning server; and wherein the user device comprises: a request module for requesting, using the API, the ordered mediation chain from the remote server; an input module configured to receive the ordered mediation chain from the remote server; and an impression content module configured to: request, from the at least one provisioning server using the API, impression content based on a first request of said plurality of requests in the ordered mediation chain; receive, from the at least one provisioning server, the requested impression content; analyze the received impression content to determine whether the received impression content meets predetermined requirements; and request, from the provisioning server using the API, further impression content based on a next request, different from the first request, of the plurality of requests in the ordered mediation chain, when it is determined that the analyzed impression content does not meet the predetermined requirements. By generating an ordered mediation chain at the remote server, where the ordered mediation chain is ordered in accordance with a predetermined metric, a user device can access suitable impression content quickly and efficiently, whilst preventing the provision of inappropriate and/or offensive impression content. Analyzing the impression content on receipt, at the user device, ensures that other impression content can be obtained from a provisioning server without delay, and in an order of preference as specified by the ordered mediation chain. This improves the user experience and reduces the processing requirements of the remote server which may be responsible for handling requests for impression content from multiple user devices.

The user device may further comprise a tendering module for initialising a tendering process, the tendering process to be executed on the at least one provisioning server, for impression content which meets the predetermined requirements, when the ordered mediation chain contains no requests for impression content meeting the predetermined requirements. This enables a tendering process to be initialized such that where there are no suitable requests for impression content, that is the impression content associated with the requests of the ordered mediation chain do not meet the predetermined requirements, suitable impression content can be obtained from a provisioning server, improving the user experience.

Preferably, wherein the user device further comprises a visual display unit for displaying at least the analyzed impression content when it is determined that the analyzed impression content meets predetermined requirements. This enables the impression content to be displayed to the user when it is determined that it is acceptable and/or suitable.

According to a fourth aspect of the present disclosure, there is provided a system for managing impression content, the system comprising at least one provisioning server arranged to generate impression content; a remote server arranged to generate an ordered mediation chain for managing a plurality of requests for the impression content, generated by the at least one server, wherein the mediation chain is ordered in accordance with a predetermined metric; and an application programming interface, API, for sending and receiving data between a user device and the remote server, wherein the remote server comprises: an input module arranged to receive a request for impression content from the user device using the API; a request module for requesting, from the at least one provisioning server, impression content, based on at least a first request of said plurality of requests of the ordered mediation chain; and an impression content module configured to receive the requested impression content from the at least one provisioning server; analyze the received impression content to determine whether the requested impression content meets predetermined requirements; and provide an indication to the request module to request further impression content based on a next request, different from the first request, of the plurality of requests in the ordered mediation chain, when the analyzed impression content does not meet the predetermined requirements. By generating an ordered mediation chain at the remote server, where the ordered mediation chain is ordered in accordance with a predetermined metric, a user device can access suitable impression content quickly and efficiently, whilst preventing the provision of inappropriate and/or offensive impression content. Analyzing the impression content on receipt, at the remote server, ensures that other impression content can be obtained from a provisioning server without delay and in an order of preference as specified by the ordered mediation chain. Furthermore, by undertaking the method at the remote server, this ensures that acceptable impression content can be obtained quicker thereby improving the user experience, and reducing the processing requirements of the user device which may be performing other processing tasks.

The remote server may comprise an impression content determination module for determining from which of the at least one provisioning server to send requests for the impression content, and a mediation chain construction module for constructing the ordered mediation chain based on the determination of the impression content determination module. The mediation chain construction module itself may comprise a metric input module for obtaining at least one of a cost metric of the impression content associated with historical data of the provisioning server providing the impression content; and a quality metric of the impression content associated with historical data of the provisioning server providing the impression content; and an ordering module for constructing the ordered mediation chain based on at least the obtained cost metric and/or quality metric. This enables the ordered mediation chain to be ordered based on the return and/or quality of each of the impression content, thereby ensuring higher quality/return impression content is requested first.

Preferably, the remote server further comprises an indication module for generating an indication that the analyzed impression content does not meet the predetermined requirements, and storing the indication in storage accessible to the provisioning server. This enables the impression content to be flagged such that inappropriate content is tracked and can be handled appropriately, by storing the indication in the storage and transmitting it to the provisioning server, future requests for the inappropriate impression content can be quickly and efficiently identified, further improving the user experience.

The remote server may comprise an output module for transmitting, to the user device using the API, the analyzed impression content when it is determined that the analyzed impression content meets the predetermined requirements. This enables the impression content to be displayed to the user when it is determined that it is acceptable and/or suitable.

According to a fifth aspect of the present disclosure, there is provided a non-transitory computer-readable storage medium comprising a set of computer-readable instructions stored thereon which, when executed by at least one processor are arranged to manage impression content at a user device, using a framework, the framework comprising at least one provisioning server configured to generate impression content; a remote server configured to generate an ordered mediation chain comprising a plurality of requests for the impression content generated by the at least one provisioning server, wherein the ordered mediation chain is ordered in accordance with a predetermined metric; and an application programming interface, API, for sending and receiving data between the user device, and the remote server and provisioning server; wherein the instructions, when executed by the at least one processor, cause the at least one processor to request, from the remote server using the API, the ordered mediation chain; receive, from the remote server, the ordered mediation chain; request, from the at least one provisioning server using the API, impression content, based on a first request of said plurality of requests of the ordered mediation chain; receive, from the at least one provision server, the requested impression content from; analyze the received impression content to determine whether the received impression content meets predetermined requirements; and request, from the provisioning server using the API, further impression content based on a next request, different from the first request, of the plurality of requests in the ordered mediation chain, when the analyzed impression content does not meet the predetermined requirements.

According to a sixth aspect of the present disclosure, there is provided a non-transitory computer-readable storage medium comprising a set of computer-readable instructions stored thereon which, when executed by at least one processor are arranged to manage impression content at a remote server, using a framework, the framework comprising at least one provisioning server configured to generate impression content; a remote server configured to generate an ordered mediation chain comprising a plurality of requests for the impression content generated by the at least one provisioning server, wherein the ordered mediation chain is ordered in accordance with a predetermined metric; and an application programming interface, API, for sending and receiving data between at least the user device and a remote server; wherein the instructions, when executed by the at least one processor cause the at least one processor to: receive, from the user device using the API, a request for impression content; request, from the at least one provisioning server, impression content, based on a first request of said plurality of requests of the ordered mediation chain; receive, from the at least one provisioning server, the requested impression content; analyze the received impression content to determine whether the received impression content meets predetermined requirements; and request, from the at least one provisioning server, further impression content based on a next request, different from the first request, of the plurality of requests in the ordered mediation chain, when the analyzed impression content does not meet the predetermined requirements.

Further features and advantages of the invention will become apparent from the following description of preferred examples of the invention, which is made with reference to the accompanying drawings.

### BRIEF DESCRIPTION OF THE DRAWINGS

FIG. 1 is a schematic diagram of a user device for showing at least impression content, according to an example;

FIG. 2 is a flowchart illustrating a method of managing impression content on a user device according to an example;

FIG. 3 is a schematic diagram of a framework for implementing the method of FIG. 2;

FIG. 4 is a schematic diagram of a user device for performing the method of FIG. 2 using the framework of FIG. 3;

FIG. 5 is a flowchart illustrating a method of managing impression content at a remote server according to an example;

FIG. 6 is a schematic diagram of a framework for implementing the method of FIG. 5; and

FIG. 7 is a schematic diagram of a remote server of the framework of FIG. 6, for performing the method of FIG. 5.

### DETAILED DESCRIPTION OF CERTAIN INVENTIVE EMBODIMENTS

Details of methods and systems according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Examples of the present disclosure relate to the management of impression content received from at least one provisioning server. The impression content is content, such as an advertisement, for which an advertiser would be charged depending on the expected or actual reach of a given advert in accordance with an advertising revenue model. In other words, the expected or actual number of “impressions” of the advert experienced by users on their devices.

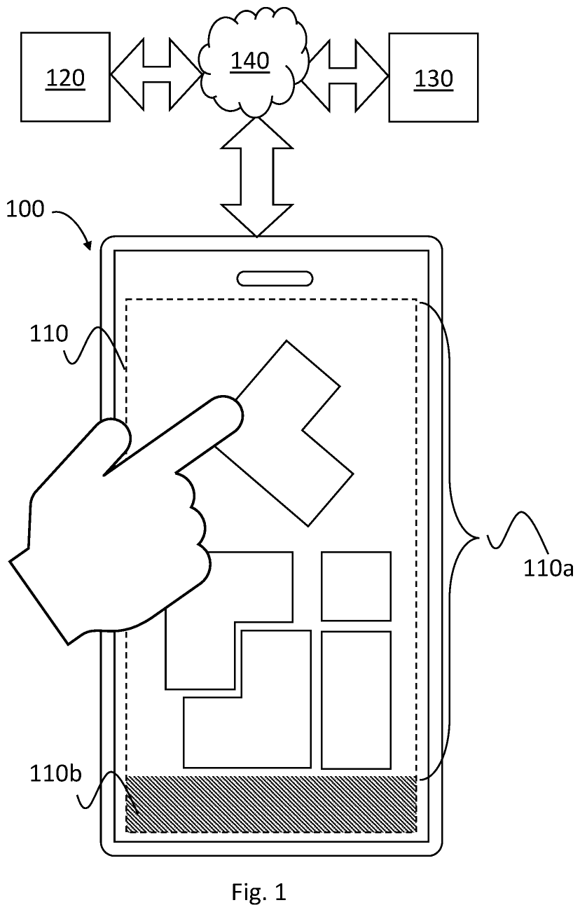

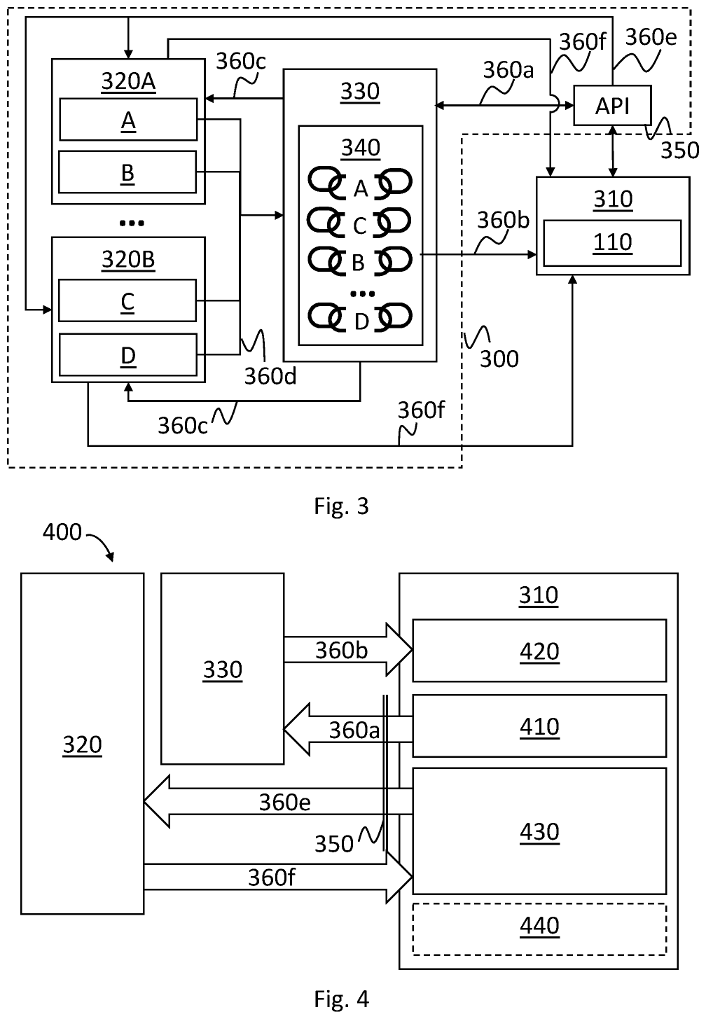

FIG. 1 shows, schematically, a user device 100 according to a first example. The user device 100 shown is a mobile telephone with a touch screen interface, however, it will be appreciated that the user device 100 may be a hand-held or laptop device, a desktop computer, a multiprocessor system, a microprocessor-based system, a smart television, or a programable consumer electronic device comprising appropriate transmitting and/or receiving capabilities. The user device 100 is arranged to receive content 110 for presentation to a user via a display associated with the user device 100. The content 110 may be generated on the device, and/or may be received from a remote server 120 which is responsible for generating the content 110. The content 110 comprises the main application content 110a and impression content 110b which is generated by at least one provisioning server 130. The user device 100, remote server 120, and provisioning server 130 are configured to communicate over a network 140, such as a local area network (LAN) or a wide area network (WAN). When generating the content 110, the main application content 110a and impression content 110b may be combined such that the impression content 110b appears to be part of the main application content 110a. Further details regarding the interaction between the remote server 120, provisioning server 130, and user device 100 will be described below with reference to FIGS. 3, 4, 6 and 7.

The main application content 110a may be any type of content, including but not limited to a game, or other productivity application. This main application content 110a may be generated on the user device 100, or in some examples, may be generated using a server, such as remote server 120, for example running on a cloud-computing platform, such that it is generated in an isolated network segment running on a remote server 120.

Cloud computing is a model for service delivery enabling on-demand network access to shared resources including processing power, memory, storage, applications, virtual machines, and services, that can be instantiated and released with minimal effort and/or interaction with the provider of the service. Cloud computing environments enable quick and cost-effective expansion and contraction of such resources by enabling the provisioning of computing capabilities, such as server time and network storage as needed. Cloud computing enables the service provider's resources to be pooled and to serve multiple consumers by dynamically assigning and reassigning physical and virtual resources on demand. Examples of such services include Amazon Web Services™ (AWS), Microsoft Azure, and Google Cloud Platform.

Services delivered using a cloud computing environment are often referred to as Software as a Service (SaaS). The applications are accessed from various user devices through a basic interface, such as a web browser or other software program. A user of the application generally has no control or knowledge over where the provided resources are located or in some examples where multiple service providers are used, which service provider is providing the resources; access to the resources of the cloud computing environments is provided via a user account object which facilitates the user's interaction with the resources allocated to a given task within the cloud computing environment. Whilst a cloud computing environment is one of the configurations capable of generating/providing the remotely-rendered content, it will be appreciated that other environments may be used, such as a collection of servers within a LAN.

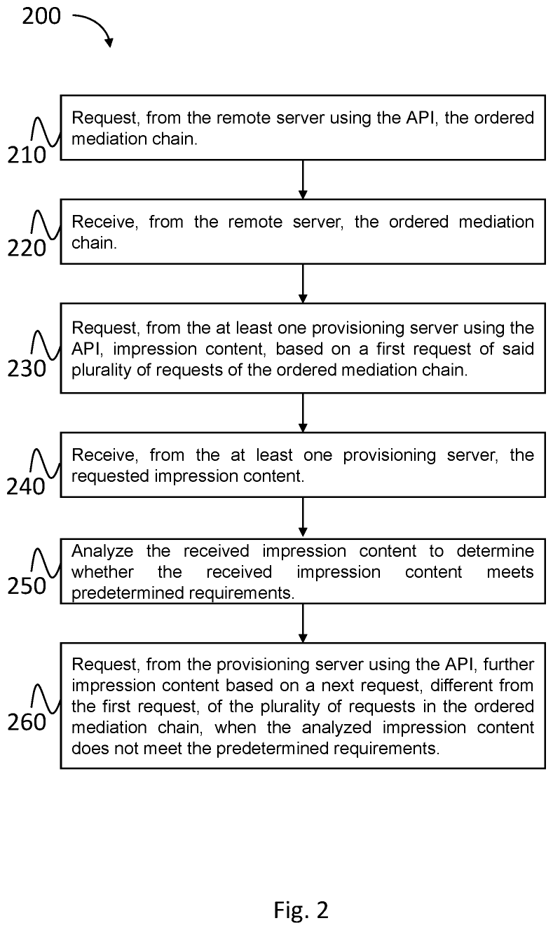

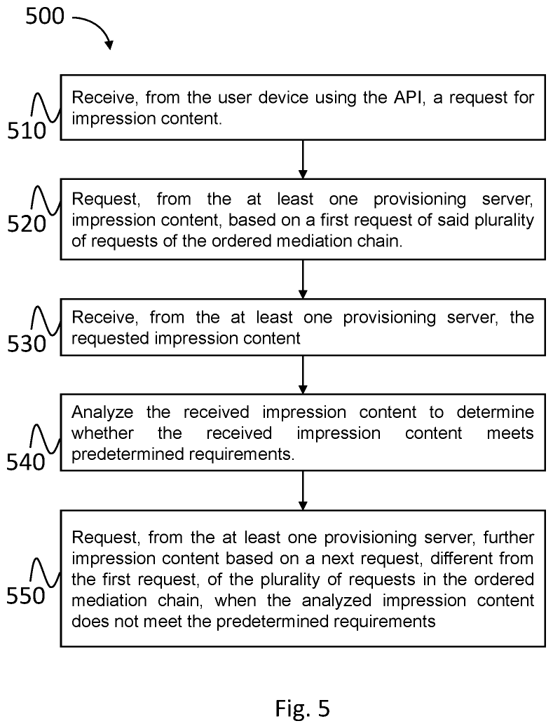

The impression content 110b may be an advertisement provided by a third-party advertising partner who has an advertising campaign configured to be presented on the user device 100, as part of the application. The advertising campaign may be configured to enable the impression content 110b to be presented in multiple different types of applications and can be targeted to specific and/or groups of applications based on several different factors. The management of the advertising campaign and other features of the impression content 110b may be handled by the provisioning server 130 and transmitted to the remote server 120 and/or user device 100 on request, as will be described with reference to the methods shown in FIG. 2 and FIG. 5, below. Such features may include an advertising revenue model associated with the impression content.

In some examples, the user device 100 may also be responsible for the transmission of data back to the remote server 120 indicating receipt of at least the impression content 110b, as well as other data such as whether the impression content 110b was viewed by the user on the display of the user device 110.

As described above, to facilitate the transmission and/or receiving capabilities, the user device 100 may comprise a network adaptor that is arranged to facilitate communication with any number of remote resources, such as the remote server 120 and/or provisioning server 130, via a network 140 such as a LAN, WAN, and/or a public network (e.g. the Internet). The network adaptor may be configured to communicate using either a wired or wireless communication method, such as cellular connectivity (LTE, 3G, 4G, or 5G), ethernet, or over a Wi-Fi network. It will be appreciated that other types of user device 100 and transmitting and/or receiving capabilities may be used.

### User Device-Based Analysis

FIG. 2 is a flowchart illustrating a method 200 for managing impression content at a user device, such as user device 100 described above with reference to FIG. 1. FIG. 3 is a schematic representation of framework 300 for implementing the method 200 described in FIG. 2, and FIG. 4 is a schematic representation of an exemplary system 400 comprising the framework 300, and an exemplary user device 310 for implementing the method 200 of FIG. 2. The method 200, framework 300, and system 400 relate to an example whereby impression content is analyzed by the user device 310, thereby ensuring that suitable impression content is available at the user device without delay and with minimal interruption. For example, the method 200 may be performed as part of an initialisation of an application, resulting in suitable impression content being available before any other content is displayed on a display of the user device 310.

A user of the user device 310 may provide an input to the user device 310 via a user interface that launches an application or other software program, such as a web browser arranged to request impression content. At step 210, the user device 310 requests 360a, from the remote server 330, an ordered mediation chain 340. The request from the user device 310 to the remote server 330 is sent via an application programming interface, API 350. The API 350 is configured to facilitate the communication between the user device 310 and the remote server 330, such that information can be passed from the user device 310 to the remote server 330 and vice versa. In some examples, the API 350 is also configured to facilitate communication between the user device 310 and the provisioning servers 320A, 320B.

The ordered mediation chain 340 is generated by the remote server 330 and comprises a plurality of requests for impression content A, B, C, D from one or more provisioning servers 320A, 320B. In the example framework 300 shown in FIG. 3, the remote server 330 tenders for impression content A, B, C, D from a plurality of provisioning servers 320A, 320B as indicated by arrow 360c. At least one provisioning server provides the impression content A, B, and C, D respectively and/or associated information as indicated by arrow 360d to the remote server 330 such that it can generate the ordered mediation chain 340. Whilst the example framework 300 shows two provisioning servers 320A, 320B each providing two different impression content A, B, C, D, it will be appreciated that there may be any number of provisioning servers 320A, 320B, each generating and/or providing any number of impression content A, B, C, D, including just one provisioning server 320A. The ordered mediation chain 340 may be ordered based on any number of criteria, including but not limited to a cost metric derived from historical data associated with the provisioning server 320A, 320B providing the impression content A, B, C, D, and stored in storage associated with the remote server 330, provisioning server 320A, 320B and/or user device 310. The cost metric may be associated with an income provided by the impression content A, B, C, D, when a user clicks and/or views the impression content. In some other examples, the ordered mediation chain 340 may be ordered in accordance with a quality metric such as the availability of the provisioning server 320A, 320B to provide the impression content A, B, C, D at a desired resolution and when requested. As with the cost metric, the quality metric may be derived from historical data associated with the provisioning servers 320A, 320B that provides the impression content A, B, C, D, and stored in storage associated with the remote server 330, provisioning server 320A, 320B and/or user device 310.

Following the request for the ordered mediation chain 340 from the remote server 330, at step 220, the ordered mediation chain 340 is sent from the remote server 330 and received via message 360b at the user device 310. As described above, the user device 310 and the remote server 330 may be communicably coupled via a network, such that the ordered mediation chain 340 is sent from the remote server 330 to the user device 310 over the network. In some examples, the ordered mediation chain 340 may be sent from the remote server 330 to the user device 310 using the API 350, or in other examples, a session between the remote server 330 and the user device 310 may be established using the API 350, and communication between the remote server 330 and user device 310 may be sent in the session.

At step 230, once the ordered mediation chain 340 is received at the user device 310, the first request in the ordered mediation chain 340 is actioned, and the user device 310 requests from the corresponding provisioning server 310A, 320B the impression content A, B, C, D associated with the first request. The requests for the first impression content A and subsequent impression content B, C, D are sent to the respective provisioning servers 320A, 320B using the API 350. In the example shown in FIG. 3, impression content A is requested first, and as such, the user device 310 requests impression content A from provisioning server 320A as indicated by arrow 360e. In some examples, as part of a previous request, a session may have been established using the API 350 between the user device 310 and a given provisioning server 320A, 320B providing the impression content A, B, C, D, such that the session can facilitate the efficient communication between the user device 310 and given provisioning server 320A, 320B in the future.

At step 240, the user device 310 receives, via messages schematically indicated as 360f in FIG. 3, the requested impression content. Following on from the example above, the first request in the ordered mediation chain 340 is for impression content A, and as such the user device 310 receives impression content A from provisioning server 320A. As described above, the requested impression content A may be received 360f from the provisioning server 320A using the API, and/or in some examples a previously established session between the provisioning server 320A and the user device 310 may be used to transmit the requested impression content A to the user device 310 over a network, such as network 150 described above.

At step 250, on receipt of the requested impression content A at the user device 310, the received impression content A is analyzed to determine whether the received impression content A, meets one or more predetermined requirements. The one or more predetermined requirements may be user-configurable, and/or may be configurable by the developer of an application arranged to display the received impression content A. The predetermined requirements may include an age-rating filter to prevent explicit and/or inappropriate content from being displayed to users, they may also include a blacklist filter specifying impression content providers who should be prevented from displaying impression content in the application. In some other examples, the predetermined requirements may include a list of approved publishers and/or provisioning servers for providing the impression content. By ensuring that the received impression content A meets the predetermined requirements, it can be determined that the received impression content A is suitable for the requesting user device 310.

As will be appreciated by the skilled person, several methodologies of analyzing the received impression content A may be used. One such methodology includes the use of machine learning to analyze the content of the received impression content A. This includes analyzing any media items contained within the received impression content A, any text within the received impression content A, and any remote content associated with the received impression content A. The remote content associated with the received impression content A may include the content of a web page linked to by the received impression content A. Other methodologies of analyzing the received impression content A may also be used, such as comparing media items in the received impression content A to a list of media content which is inappropriate, and/or comparing text in the received impression content A to a banned words dictionary.

Following the analysis by the user device 310, at step 260, if the received impression content A does not meet the predetermined requirements the user device 310 is configured to request further impression content, that being one or more of impression content B, C, D which is yet to be requested, and which is based on the requests in the ordered mediation chain 340. As described above, the ordered mediation chain 340 comprises requests for impression content A, B, C, D from a plurality of provisioning servers 320A, 320B, wherein the requests are ordered in accordance with one or more predetermined metrics. As the received impression content A associated with the first request in the ordered mediation chain 340 does not meet the predetermined requirements, the user device 310 requests further impression content, based on the next request in the ordered mediation chain 340. In the example of FIG. 3, the next request is a request for impression content C from provisioning server 320B. In some examples, following the request for the further impression content C, the user device 310 will repeat the analysis step described above, to determine whether the further impression content C meets the predetermined requirements. If not, then the impression content B associated with the next request in the ordered mediation chain 340 will be requested from the provisioning server 320A.

In some examples, the user device 310 may exhaust the requests in the ordered mediation chain 340 as, based on the analysis undertaken, all the impression content A, B, C, D associated with the requests may fail to meet the predetermined requirements. In such an example, a tendering process may be initialised and executed on the at least one provisioning server 320A, 320B for impression content which meets the predetermined requirements. This ensures that impression content meeting the predetermined requirements is provided to the user device 310 as often as possible. In yet further examples, default impression content may be provided to the user device 310 whilst the tendering process is being executed.

Once the impression content A, B, C, D, whether it be the impression content A associated with the first request or the further impression content C associated with a second or subsequent request, has been analyzed and it is determined that it meets the predetermined requirements (or impression content is provided as part of the above-mentioned tendering process), the impression content that meets the requirements may be displayed on a display associated with the user device 310. This may be in a predefined area of the display, and/or as part of a software program currently being executed by the user device 310.

FIG. 4 is a schematic diagram of a system 400 comprising a user device 310 configured to perform method 200 described above. The user device 310 may be a computing device, such as a smartphone, laptop computing device, desktop computing device, wearable device, and/or tablet computing device. It will be appreciated that the user device 310 may be any number of other types of device. The user device 310 comprises a request module 410 for requesting 360a using the API 350 an ordered mediation chain, such as ordered mediation chain 340 described above with reference to FIG. 3, from the remote server 330. Upon receipt of the request 360a from the user device 310, the remote server sends 360b the ordered mediation chain to the user device 310. The ordered mediation chain may be sent to the user device 310 using the API 350, however, it will be appreciated that in some examples, when the user device 310 sends the request 360a to the remote server 330, a session may be initialised to facilitate direct communication between the user device 310 and the remote server 330 over a network.

The user device 310 also comprises an input module 420 configured to receive the ordered mediation chain. As described above this may be received using the API 350, or in some examples via an already established session. In some examples, the user device 310 may also have access to storage (not shown). The storage may be a solid-state drive (SSD) or other semiconductor-based RAM; a magnetic recording medium, for example, a floppy disk or hard disk; optical memory devices in general, although it will be appreciated that other storage mediums may be used. The storage may be part of the user device 310 itself, however, it will be appreciated that the storage may be storage that is remote to the user device 310 and accessed by the user device over a network connection.

The user device 310 also comprises an impression content module 430 arranged to request 360e impression content from at least one provisioning server 320 based on a first request in the ordered mediation chain as described above with reference to step 230. As has been explained above with reference to particular examples, the first request in the ordered mediation chain represents preferred impression content, according to a predetermined metric. The impression content module 430 receives 360f the requested impression content from the associated provisioning server 320 and analyzes the received impression content to determine whether it meets predetermined requirements as described above with reference to step 250 of method 200.

If the analyzed impression content does not meet one or more predetermined requirements, the next request in the ordered mediation chain is issued by the impression content module 430 to obtain further impression content as described above with reference to step 260 of method 200. The analysis is then repeated on the further impression content to determine whether it meets the predetermined requirements. This process is repeated until the analyzed impression content meets the predetermined requirements, or there are no further requests in the ordered mediation chain.

In some examples, the user device 310 comprises a visual display unit (not shown) capable of displaying the analyzed impression content. In such examples, if the analyzed impression content meets the predetermined requirements, the analyzed impression content may be provided to the visual display unit of the user device 310, to be displayed to the user, either on its own or as part of another application currently being executed by a processor of the user device.

In yet further examples, the user device 310 may comprise a tendering module 440 for initiating a tendering process to be executed on the provisioning servers 320 when there are no requests in the ordered mediation chain 340 for impression content which meets the predetermined requirements. The tendering process may have specific criteria to ensure that the impression content requested for the provisioning servers meets the predetermined requirements.

To facilitate the transmission and/or receiving capabilities, the user device 310 may comprise a network adaptor that is arranged to facilitate communication with any number of remote resources, such as the remote server 330 and/or the provisioning server 340, via a network such as a local area network (LAN), a general wide area network (WAN), and/or a public network (e.g. the Internet). The network adaptor may be configured to communicate using either a wired or wireless communication method, such as cellular connectivity (LTE, 3G, 4G, or 5G), ethernet, or over a Wi-Fi network. It will be appreciated that other types of user device 110 and transmitting and/or receiving capabilities may be used.

### Remote Server-Based Analysis

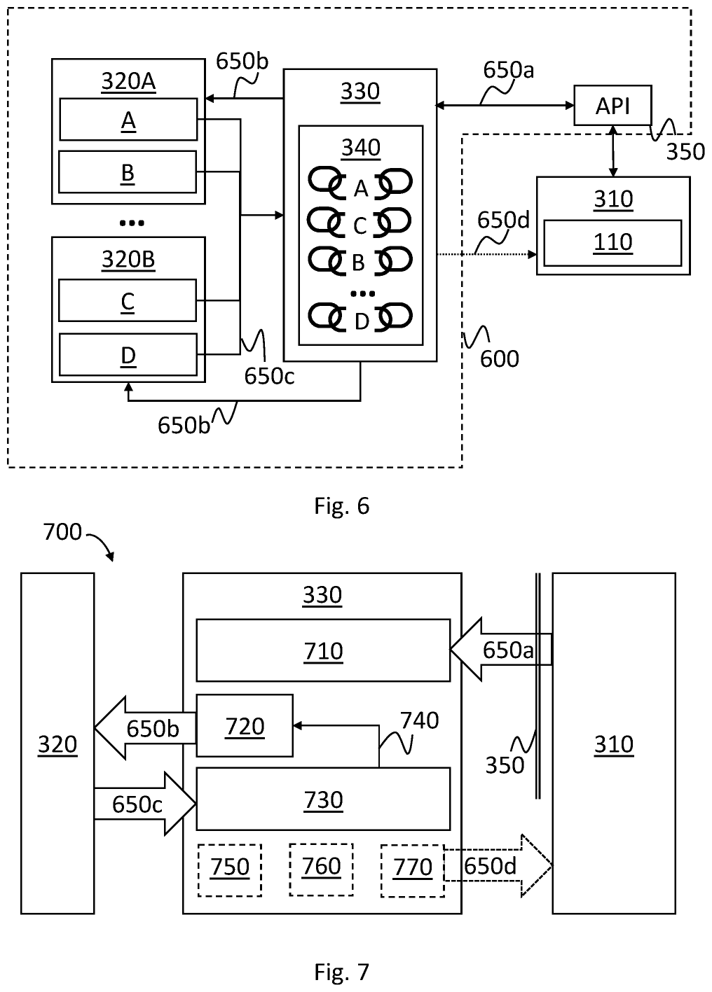

FIG. 5 is a flowchart illustrating a method 500 for managing impression content at a user device, such as user device 100 described above with reference to FIG. 1. FIG. 6 is a schematical representation of framework 600 for implementing the method 500 described in FIG. 2, and FIG. 4 is a schematic representation of an exemplary system 700 comprising the framework 600, an exemplary user device 310, and a remote server 330 for implementing the method 500 of FIG. 5. The method 500, framework 600, and system 700 relate to an example whereby impression content is analyzed by the remote device 330. A user of the user device 310 may provide an input to the user device 310 via a user interface that launches an application or other software program, such as a web browser arranged to request impression content. At step 510, the user device 310 requests 650a from the remote server 330 impression content A, B, C, D. The request from the user device 310 to the remote server 330 is sent via an application programming interface, API 350. The API 350 is configured to facilitate the communication between the user device 310 and the remote server 330, such that information can be passed from the user device 310 to the remote server 330 and vice versa.

In some examples, the remote server 330 has access storage (not shown) which contains an ordered mediation chain, such as the ordered mediation chain 340 described above with reference to FIG. 3. The storage may be a solid-state drive (SSD) or other semiconductor-based RAM; a magnetic recording medium, for example, a floppy disk or hard disk; optical memory devices in general, although it will be appreciated that other storage mediums may be used. The storage may be part of the remote server 330 itself, however, it will be appreciated that the storage may be storage that is remote to the remote server 330 and accessed by the remote server 330 over a network connection.

The ordered mediation chain 340 is generated by the remote server 330 and comprises a plurality of requests for impression content A, B, C, D from one or more provisioning servers 320A, 320B. In the example framework 600 shown in FIG. 6, the remote server 330 sends requests for impression content A, B, C, D from a plurality of provisioning servers 320A, 320B as indicated by arrow 660b. At least one provisioning server provides the impression content A, B, C, D and/or associated information as indicated by arrow 360d to the remote server 330 such that it can generate the ordered mediation chain 340. Whilst the example framework 300 shows two provisioning servers 320A, 320B each providing two different impression content A, B, and C, D, respectively it will be appreciated that there may be any number of provisioning servers 320A, 320B, each generating and/or providing any number of impression content A, B, C, D, including just one provisioning server 320A. The ordered mediation chain 340 may be ordered based on any number of criteria, including but not limited to a cost metric derived from historical data associated with the provisioning server 320A, 320B providing the impression content A, B, C, D, and stored in storage associated with the remote server 330, provisioning server 320A, 320B and/or user device 310. The cost metric may be associated with an income provided by the impression content A, B, C, D, when a user clicks and/or views the impression content. In some other examples, the ordered mediation chain 340 may be ordered in accordance with a quality metric such as the availability of the provisioning server 320A, 320B to provide the impression content A, B, C, D at a desired resolution and when requested. As with the cost metric, the quality metric may be derived from historical data associated with the provisioning servers 320A, 320B that provides the impression content A, B, C, D, and stored in storage associated with the remote server 330, provisioning server 320A, 320B and/or user device 310.

Once the request 650a for the impression content from the user device 310 is received at the remote server 330, at step 520 the first request in the ordered mediation chain 340 is actioned, and the user device 310 requests from the corresponding provisioning server 310A, 320B the impression content associated with the first request. The requests for the first impression content A and subsequent impression content B, C, D are sent to the respective provisioning servers 320A, 320B using a provisioning server API (not shown). In the example shown in FIG. 6, impression content A requested first. As such, the remote server 330 requests impression content A from provisioning server 320A as indicated by arrow 650b. In some examples, a session may be established between the remote server 330 and a given provisioning server 320A, 320B providing the impression content A, B, C, D, such that the session can facilitate the efficient communication between the remote server 330 and given provisioning server 320A, 320B in the future.

At step 530, the remote server 330 receives, via messages schematically indicated as 650c in FIG. 6, the requested impression content. As explained above, the first request in the ordered mediation chain is for impression content A, and as such the remote server 330 receives impression content A from provisioning server 320A. As also described above, the requested impression content A may be received 650c from the provisioning server 320A using the above-mentioned provisioning server API (not shown), and/or in some examples, a previously established session between the provisioning server 320A and the remote server 330 may be used to transmit the requested impression content A to the remote server 330 over a network, such as network 150 described above.

At step 540, following receipt of the requested impression content A at the remote server 330 the received impression content A is analyzed to determine whether the received impression content A meets one or more predetermined requirements. The one or more predetermined requirements may be user-configurable, and/or may be configurable by the developer of an application arranged to display the received impression content A. The predetermined requirements may include an age-rating filter to prevent explicit and/or inappropriate content from being displayed to users, they may also include a blacklist filter specifying impression content providers who should be prevented from displaying impression content in the application. In some other examples, the predetermined requirements may include a list of approved publishers and/or provisioning servers for providing the impression content. By ensuring that the received impression content A meets the predetermined requirements, it can be determined that the received impression content A is suitable for the user device 310 that initially requested impression content.

As will be appreciated by the skilled person, several methodologies of analyzing the received impression content A may be used. One such methodology includes the use of machine learning to analyze the content of the received impression content A. This includes analyzing any media items contained within the received impression content A, any text within the received impression content A, and any remote content associated with the received impression content A. The remote content associated with the received impression content A may include the content of a web page linked to by the received impression content A. Other methodologies of analyzing the received impression content A may also be used, such as comparing media items in the received impression content A to a list of media content which is inappropriate, and/or comparing text in the received impression content A to a banned words dictionary.

Following the analysis by the remote server 330, at step 550, if the received impression content A does not meet the predetermined requirements, the remote server 330 is configured to request further impression content, that being impression content B, C, D which is yet to be requested, and which is based on the requests in the ordered mediation chain 340. As described above, the ordered mediation chain 340 comprises requests for impression content A, B, C, D from a plurality of provisioning servers 320A, 320B, wherein the requests are ordered in accordance with one or more predetermined metrics. As the received impression content A, associated with the first request in the ordered mediation chain 340, does not meet the predetermined requirements, the remote server 330 requests further impression content based on the next request in the ordered mediation chain 340. In the example of FIG. 6, the next request is a request for impression content C from provisioning server 320B. In some examples, following the request for the further impression content C, the remote server 330 will repeat the analysis step described above, to determine whether the further impression content C meets the predetermined requirements. If not, then the impression content B associated with the next request in the ordered mediation chain 340 will be requested from the provisioning server 320A.

In some examples, when it is determined that the analyzed impression content does not meet the predetermined requirements, the analyzed impression content may be stored in storage accessible to the provisioning servers 320A, 320B along with an indication that the analyzed impression content does not meet the predetermined requirements. Furthermore, in some examples, the indication may be transmitted directly to the respective provisioning server 320A, 320B, such that the related impression content can be flagged to prevent transmission to the remote server 330 in response to further requests for that impression content, thereby saving bandwidth. The storage accessible by the provisioning servers 320A, 320B may be a solid-state drive (SSD) or other semiconductor-based RAM; a magnetic recording medium, for example, a floppy disk or hard disk; optical memory devices in general, although it will be appreciated that other storage mediums may be used. The storage may be the same storage described above with reference to the remote server storage or may be separate. In some examples the storage may be part of each provisioning server 320A, 320B, however, it will be appreciated that the storage may be storage that is remote to the provisioning servers 320A, 320B and accessed by each provisioning server 320A, 320B over a network connection.

In yet further examples, once the impression content A, B, C, D, whether it be the impression content A associated with the first request or the further impression content C associated with a second or subsequent request, has been analyzed and it is determined that it meets the predetermined requirements (or impression content is provided as part of the tendering process described above), the impression content meeting the requirements may be transmitted 650d to the user device 310 for display on a visual display unit associated with the user device 310. The impression content that is determined to meet the predetermined requirements may be transmitted to the user device 310 using the API 350, or in some examples may be transmitted directly using an already established session between the user device 310 and the remote server 330.

FIG. 7 is a schematic diagram of a system 700 comprising a remote server 330 configured to perform method 500 described above. The remote server 330 may be a network-connected computing device arranged to send and/or receive commands from a plurality of user devices 310. The user device 310 may also be a computing device, such as a smartphone, laptop computing device, desktop computing device, wearable device, and/or tablet computing device as described above.

The remote server 330 comprises an input module 710 configured to receive a request 650a for impression content from a user device 310. As described above this may be received using the API 350, or in some examples via an already established session as described above.

In some examples, the remote server 330 may also have access to storage (not shown). The storage may be a solid-state drive (SSD) or other semiconductor-based RAM; a magnetic recording medium, for example, a floppy disk or hard disk; optical memory devices in general, although it will be appreciated that other storage mediums may be used. The storage may be part of the remote server 330 itself, however, it will be appreciated that the storage may be storage that is remote to the user device 310 and accessed by the user device 310 over a network connection. The storage may be configured to store an ordered mediation chain, such as the ordered mediation chain 340 described above.

The remote server 330 also comprises a request module 720 for requesting 650b impression content, such as impression content A, B, C, D from one or more provisioning servers 320A, 320B. The request module 720 is configured to request 650b impression content A, B, C, D from the provisioning servers 320A, 320B in accordance with the requests in the ordered mediation chain, such as the ordered mediation chain 340 described above. Initially, the request module 720 is configured to issue a request for impression content A, B, C, D based on a first request of the ordered mediation chain. The first request in the ordered mediation chain 340 may represent preferred impression content, that being impression content A in the examples described above, according to a predetermined metric.

An impression content module 730 of the remote server 330 is configured to receive 650c the requested impression content from at least one provisioning server 320 in response to the request 650b issued by the request module 720. The impression content module 720 then analyzes the received impression content to determine whether it meets predetermined requirements as described above with reference to step 540 of method 500.

If the analyzed impression content does not meet one or more predetermined requirements, the impression content module 720 provides an indication 740 to the request module 720 to issue the next request in the ordered mediation chain. The next request is for further impression content as described above with reference to step 550 of method 500. The analysis is then repeated, by the impression content module 720, for the further impression content to determine whether it meets the predetermined requirements. This process is repeated until the analyzed impression content meets the predetermined requirements, or there are no further requests in the ordered mediation chain.

As mentioned above, the remote server 330 is configured to generate an ordered mediation chain 340 for requesting different impression content from at least one provisioning server 320. The ordered mediation chain is ordered in accordance with a predetermined metric. As such, in some examples, the remote server 330 may comprise an impression content determination module 750 configured to determine from which of the provisioning servers 320 to send requests for impression content. The impression content determination module 750 may analyze several factors when determining whether to send requests to the provisioning servers 320. For example, the strength and/or reliability of the connection between the provisioning server 320 and the remote server 330 may be considered.

The remote server 330 may also comprise a mediation chain construction module 760 for generating the ordered mediation chain based on the requests sent to the provisioning server by the impression content determination module 750. The mediation chain construction module 760 itself may also comprise a metric input module (not shown) for obtaining metrics associated with the requested impression content A, B, C, D. Examples of such metrics include a cost metric and a quality metric. The cost metric may be derived from historical data associated with the provisioning server 320 providing the impression content and may be associated with an income provided by the impression content when a user clicks and/or views the impression content. The quality metric may be derived from the availability of the provisioning server 320 to provide the impression content at the desired resolution and when requested. As with the cost metric, the quality metric may be derived from historical data associated with the provisioning server 320 that provides the impression content. The mediation chain construction module 760 may also comprise an ordering module (not shown) for constructing the ordered mediation chain based on at least the cost metric and the quality metric obtained by the metric input module.

In some examples, the remote server 330 comprises an output module 770 for transmitting 650d the analyzed impression content to the user device 310 when it is determined that the analyzed impression content meets the predetermined requirements. The analyzed impression content may be transmitted 650d to the user device 310 using the API, or in some examples may be transmitted directly using an already established session between the user device 310 and the remote server 330.

To facilitate the transmission and/or receiving capabilities, the remote server 330 may comprise a network adaptor that is arranged to facilitate communication with any number of remote resources, such as the user device 310 and/or the provisioning server 340, via a network such as a local area network (LAN), a general wide area network (WAN), and/or a public network (e.g. the Internet). The network adaptor may be configured to communicate using either a wired or wireless communication method, such as cellular connectivity (LTE, 3G, 4G, or 5G), ethernet, or over a Wi-Fi network. It will be appreciated that other types of user device 110 and transmitting and/or receiving capabilities may be used.

At least some aspects of the examples described herein with reference to FIGS. 1-7 comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A method for managing impression content at a user device using a framework, the framework comprising:
at least one provisioning server configured to generate impression content;
a remote server configured to generate an ordered mediation chain comprising a plurality of requests for the impression content generated by the at least one provisioning server, wherein the ordered mediation chain is ordered in accordance with a predetermined metric; and
an application programming interface, API, for sending and receiving data between the user device, and the remote server and the provisioning server;
the method comprising:
requesting, from the remote server using the API, the ordered mediation chain;
receiving, from the remote server, the ordered mediation chain;
requesting, from the at least one provisioning server using the API, impression content, based on a first request of said plurality of requests of the ordered mediation chain;
receiving, from the at least one provisioning server, the requested impression content;
analyzing the received impression content to determine whether the received impression content meets predetermined requirements; and
requesting, from the provisioning server using the API, further impression content based on a next request, different from the first request, of the plurality of requests in the ordered mediation chain, when the analyzed impression content does not meet the predetermined requirements.

2. The method for managing impression content at the user device according to claim 1, further comprising the step of initialising a tendering process, the tendering process to be executed on the at least one provisioning server, for impression content which meets the predetermined requirements, when the ordered mediation chain contains no requests for the impression content meeting the predetermined requirements.

3. The method for managing impression content at the user device according to claim 2, wherein default impression content is shown during execution of the tendering process.

4. The method for managing impression content at the user device according to claim 1, wherein the step of analyzing the received impression content comprises applying at least one machine learning algorithm to analyze at least:
any media items contained within the impression content;
any text contained within the impression content; and
any remote content associated with the impression content.

5. The method for managing impression content at the user device according to claim 1, wherein the predetermined metric is based on at least one of:
a cost metric of the impression content associated with historical data of the provisioning server providing the impression content; and
a quality metric of the impression content associated with historical data of the provisioning server providing the impression content.

6. The method for managing impression content at the user device according to claim 1, wherein the predetermined requirements include at least one of:
an age rating filter;
a blacklist filter;
a list of approved publishers of the impression content; and
a list of approved provisioning servers for providing the impression content.

7. The method for managing impression content at the user device according to claim 1, wherein the predetermined requirements are configurable by a user of the user device.

8. A method for managing impression content at a remote server using a framework, the framework comprising:
at least one provisioning server configured to generate impression content;
a remote server configured to generate an ordered mediation chain comprising a plurality of requests for the impression content generated by the at least one provisioning server, wherein the ordered mediation chain is ordered in accordance with a predetermined metric;
an application programming interface, API, for sending and receiving data between at least the user device and the remote server;
the method comprising:
receiving, from the user device using the API, a request for impression content;
requesting, from the at least one provisioning server, impression content, based on a first request of said plurality of requests of the ordered mediation chain;
receiving, from the at least one provisioning server, the requested impression content;
analyzing the received impression content to determine whether the received impression content meets predetermined requirements; and
requesting, from the at least one provisioning server, further impression content based on a next request, different from the first request, of the plurality of requests in the ordered mediation chain, when the analyzed impression content does not meet the predetermined requirements.

9. The method for managing impression content at the remote server according to claim 8, wherein the remote server, on receipt of the request for the ordered mediation chain, determines which of the at least one provisioning server to send requests for the impression content, and constructs the ordered mediation chain based on the determination.

10. The method for managing impression content at the remote server according to claim 8, further comprising the step of ordering the ordered mediation chain in accordance with a predetermined metric, wherein the predetermined metric is at least one of:
a cost metric of the impression content associated with historical data of the provisioning server providing the impression content; and
a quality metric of the impression content associated with historical data of the provisioning server providing the impression content.

11. The method for managing impression content at the remote server according to claim 8, further comprising storing the analyzed impression content in storage accessible to the provisioning server, and storing an indication in the storage that the analyzed impression content does not meet the predetermined requirements.

12. The method for managing impression content at the remote server according to claim 11, further comprising transmitting, to the provisioning server, the indication, when it is determined that the impression content does not meet the predetermined requirements.

13. The method for managing impression content at the remote server according to claim 8, further comprising transmitting, to the user device using the API, the analyzed impression content, when it is determined that the analyzed impression content meets the predetermined requirements.

14. A user device configured to manage impression content requested from a distributed system, the distributed system comprising:
at least one provisioning server configured to generate impression content;
a remote server configured to generate an ordered mediation chain for managing a plurality of requests for the impression content, generated by the at least one server, wherein the mediation chain is ordered in accordance with a predetermined metric;
an application programming interface, API, for sending and receiving data between the user device, and the remote server and the provisioning server; and
wherein the user device comprises:
a request module configured to request, using the API, the ordered mediation chain from the remote server;
an input module configured to receive the ordered mediation chain from the remote server; and
an impression content module configured to:
request, from the at least one provisioning server using the API, impression content based on a first request of said plurality of requests in the ordered mediation chain;
receive, from the at least one provisioning server, the requested impression content;
analyze the received impression content to determine whether the received impression content meets predetermined requirements; and
request, from the provisioning server using the API, further impression content based on a next request, different from the first request, of the plurality of requests in the ordered mediation chain, when it is determined that the analyzed impression content does not meet the predetermined requirements.

15. The user device for managing impression content according to claim 14, wherein the user device further comprises a tendering module for initialising a tendering process, the tendering process to be executed on the at least one provisioning server, for impression content which meets the predetermined requirements, when the ordered mediation chain contains no requests for impression content meeting the predetermined requirements.

16. A system for managing impression content, the system comprising:
at least one provisioning server arranged to generate impression content;
a remote server arranged to generate an ordered mediation chain for managing a plurality of requests for the impression content, generated by the at least one server, wherein the mediation chain is ordered in accordance with a predetermined metric; and
an application programming interface, API, for sending and receiving data between a user device and the remote server,
wherein the remote server comprises:
an input module configured to receive a request for impression content from the user device using the API;
a request module configured to request, from the at least one provisioning server, impression content, based on at least a first request of said plurality of requests of the ordered mediation chain; and
an impression content module configured to:
receive the requested impression content from the at least one provisioning server;
analyze the received impression content to determine whether the requested impression content meets predetermined requirements; and
provide an indication to the request module to request further impression content based on a next request, different from the first request, of the plurality of requests in the ordered mediation chain, when the analyzed impression content does not meet the predetermined requirements.

17. The system for managing impression content according to claim 16, wherein the remote server comprises:
an impression content determination module for determining from which of the at least one provisioning server to send requests for the impression content, and
a mediation chain construction module for constructing the ordered mediation chain based on the determination of the impression content determination module.

18. The system for managing impression content according to claim 17, wherein the mediation chain construction module comprises:
a metric input module for obtaining at least one of:
a cost metric of the impression content associated with historical data of the provisioning server providing the impression content; and
a quality metric of the impression content associated with historical data of the provisioning server providing the impression content; and
an ordering module for constructing the ordered mediation chain based on at least the obtained cost metric and/or quality metric.

19. The system for managing impression content according to claim 16, wherein the remote server further comprises an indication module for generating an indication that the analyzed impression content does not meet the predetermined requirements, and storing the indication in storage accessible to the provisioning server.

20. The system for managing impression content according to claim 16, wherein the remote server further comprises an output module for transmitting, to the user device using the API, the analyzed impression content when it is determined that the analyzed impression content meets the predetermined requirements.
